(19) United States
(12) Patent Application Publication
(10) Pub. No.: US 2005/0166184 A1
(43) Pub. Date: Jul. 28, 2005

(54) Information processing apparatus and storage medium in which information processing program is stored

(75) Inventor: Nobuyuki Takao, Kawasaki-shi (JP)

Correspondence Address: OLIFF & BERRIDGE, PLC, P.O. BOX 19928, ALEXANDRIA, VA, 22320, US

(73) Assignee: FUJI XEROX CO., LTD., Tokyo (JP)

(21) Appl. No.: 10/940,953

(22) Filed: Sep. 15, 2004

(30) Foreign Application Priority Data
Jan. 6, 2004 (JP) 2004-1365

(51) Int. Cl. G06F 9/44

(52) U.S. Cl. 717/117

(57) ABSTRACT

The invention provides an information processing apparatus, which performs a predetermined series of processes to document information in cooperation with an external device. The information processing apparatus includes: a display that displays an operation designation input screen, a rule information input screen and a determining button, which is designated when inputting of an operation designation and a rule information has been terminated and an input result has been determined, a decision unit that decides, when the determining button is designated, whether an operation for the job flow can be executed; and a controller that controls the display in such a way that the display displays, when the decision unit decides that an operation cannot be executed, a reason why the operation cannot be executed, and displays also a re-execution button, which is to be designated when the operation is re-executed.

### CROSS-REFERENCE TO RELATED APPLICATIONS

This application claims priority under 35USC 119 from Japanese Patent Application No. 2004-1365, the disclosure of which is incorporated by reference herein.

### BACKGROUND OF THE INVENTION

1. Field of the Invention

The present invention relates to an information processing apparatus, and to a storage medium in which an information processing program is stored and, in particular to an information processing apparatus which can be used to advantage in a network system in which paper documents and electronic information are designed to be used in combination with each others, and a storage medium in which an information processing program can be used to advantage within such a network system.

2. Description of the Related Art

A conventional network system is known in which a scanner, a facsimile (on occasions referred to hereinafter as a FAX), and a copying machine, or a compound machine obtained by combining these three types of machine, a personal computer, and a mail server are all connected through a network to achieve a network system in which paper documents and electronic information can be used in combination with one another.

According to such a network system, a document file is obtained from an input system, such as a scanner or a paper-less FAX, which reads an original document, the document file is then processed by means of a processing system which undertakes processes such as image processing and character recognition, and the document file is then delivered to an external destination through an output system such as a printer or a mail server.

In general, each of the processes of obtention, processing, and delivery of a document file is performed independently. For this reason, when a user desires to execute continuously the obtention, processing, and delivery of a document file, she/he must settle on predetermined settings for each of the processes of obtention, processing, and delivery. More specifically, in order to perform predetermined input operations, users have been forced to go to considerable efforts to open individually windows related to the obtention, processing, and delivery processes.

For this reason, conventional workflow systems have been introduced which execute in a predefined order, and in cooperation with devices in a network a series of processes beginning with obtention and ending with delivery. These work flow systems have frequently been developed by merely computerizing existing paper-based work-flow administrative system of the kind traditionally used in offices for obtaining and granting approval, and for the circulation of documents.

In work systems of this type, after a series of processes beginning with obtention and ending with delivery have been defined, the series of processes can be repeatedly executed in accordance with this definition. However, the following kind of configuration may also be used. That is, once definition has been completed information (job flow) for executing a series of processes, in respect of multiple devices connected by a network, is delivered, stored, and executed, and the devices accordingly perform the series of processes in cooperation with each other.

Since this kind of configuration is executed by storing in advance a job flow in respect of various devices connected by a network, the following various operations may need to be performed. That is, when a new job flow is formed, the job flow is delivered to, and stored in, an appropriate device, and job flows already stored in devices are updated or deleted.

In these circumstances, after designations of various operations for a job flow have been input, and after definitions have been completed, operations depending on input designations for the job flow are preferably respectively reflected in the corresponding devices. This is because all settings are completed once a definition has been determined. Until definitions have been determined, operation contents for a job flow may be changed, or the job flow itself may on occasions be changed. However, it is extremely disadvantageous in terms of the processing load if each time that changes are made conditions existing such changes have been made have to be reflected in each device.

In these circumstances, the time lag between a time when the designation of an operation for a job flow has been input and a time when the definition is completed may not be short. Thus, during this time lag, for example, the power supply for a device corresponding to a location where a job flow to be operated is stored may be turned off, an account having a right to access a device may be changed, or a user may erroneously delete a folder serving as a location where the job flow is to be delivered, and in such ways conditions within the system may change radically.

However, related art can not cope with such changes of conditions within the system, and for this reason, the following problem arises. That is, due to changes in conditions it becomes impossible to reflect in devices the operations for the job flow. Even when, for the above reason, an error may have been generated, a user cannot recognize this kind of error and take appropriate counter measures.

### SUMMARY OF THE INVENTION

The present invention has been made in view of the above circumstances and provides an information processing apparatus and a storage medium in which an information processing program is stored.

An information processing apparatus according to a first aspect of the invention is an information processing apparatus, which performs a predetermined series of processes to document information in cooperation with an external device according to a job flow which expresses a plurality of processes performed to document information, the information processing apparatus comprising: a display that displays an operation designation input screen that inputs an operation designation for the job flow and a rule information input screen that inputs rule information serving as information which defines rules for conditions of cooperation with the external device, and a determining button, which is designated when inputting of the operation designation and the rule information has been terminated and an input result has been determined; a decision unit that decides, when the determining button is designated, whether an operation for the job flow can be executed by the operation designation; and a controller that controls the display in such a way that the display displays, when the decision unit decides that an operation cannot be executed, a reason why the operation cannot be executed, and displays also a re-execution button, which is to be designated when the operation is re-executed.

In the information processing apparatus according to the first aspect, a job flow obtained by expressing in the form of a single series of processes multiple processes performed to document information is transmitted to an external device which performs a series of processes to the document information in order to store and execute a series of processes, thus enabling the information processing apparatus to perform one predetermined series of processes to the document information in cooperation with the external device. The apparatus comprises a display, which displays an operation designation input screen for inputting an operation designation for the job flow; a rule information input screen for inputting rule information serving as information that defines rules for conditions of co-operation with the external device, and also a determining button designated when inputting of the operation designation and the rule information has been terminated and an input result determined. The display can include displays such as a liquid crystal display, a CRT display, an organic EL display, and a plasma display. The document information may be information related to a document, and is not limited to image information or the like obtained by reading character information such as text data or a paper document.

In the invention, when the determining button is designated, the decision unit decides whether an operation for the job flow can be executed by the operation designation, and when the decision unit decides that an operation cannot be executed, the controller controls the display in such a way that the display displays, a reason why the operation cannot be executed, and displays also a re-execution button, which is to be designated when the operation is re-executed.

In this manner, in the information processing apparatus according to the first aspect, when a job flow obtained by expressing in the form of a single series of processes multiple processes performed to document information is transmitted to an external device, the external device performs a series of processes to the document information in order to store and execute the series of processes, thus enabling the information processing apparatus to perform one predetermined series of processes to the document information in cooperation with the external device; a display displays an operation designation input screen for inputting an operation designation for the job flow; a rule information input screen for inputting rule information serving as information which defines rules for conditions of cooperation with the external device, and a determining button designated when inputting of the operation designation and the rule information has been terminated and an input result has been determined. When the determining button is designated, it is thus decided whether an operation for the job flow can be executed by the operation designation, and the display is controlled in such a way that the display displays, when the decision unit decides that the operation cannot be executed, a reason why the operation cannot be executed, and also a re-execution button which is designated when the operation is re-executed. For this reason, condition within the system began to change when inputting of the operation designation for the job flow has been terminated. Even when an operation dependent on the input operation designation cannot be executed, the reason why the operation cannot be executed can be easily recognized by referring to the display contents on the display. As a result, measures to counter the fact that an operation dependent on the operation designation cannot be executed can be easily adopted, and once these measures have been adopted the operation for the job flow can be easily re-executed by merely designating the re-execution button.

A second aspect of the invention provides a storage medium readable by a computer, the storage medium storing a program of instructions executable by the computer to perform a function for performing a predetermined series of processes to document information in cooperation with an external device according to a job flow which expresses a plurality of processes performed to document information, the function comprising: (a) displaying an operation designation input screen that inputs an operation designation for the job flow, a rule information input screen that inputs rule information serving as information which defines rules for conditions of cooperation with the external device, and a determining button, which is to be designated when inputting of the operation designation and the rule information has been terminated and an input result has been determined; (b) deciding, when the determining button is designated, whether an operation for the job flow can be executed by the operation designation; and (c) when it is decided that an operation cannot be executed in (b), displaying on the display a reason why the operation cannot be executed, and displaying a re-execution button, which is to be designated when the operation is re-executed.

Therefore, according to the storage medium in which the information processing program described in the second aspect is stored, the information processing program can be operated as in the first aspect of the invention. For this reason, as in the first aspect of the invention, even when conditions with the system have started to change after inputting of an operation designation for a job flow has been terminated, thus making it impossible to execute an operation dependent on the input operation designation, a reason why the operation cannot be executed can be easily recognized by referring to the display contents on the display. As a result, measures can be easily adopted to counter the fact that an operation dependent on the operation designation cannot be executed, and once these measures have been adopted an operation for a job flow can be re-executed merely by designating the re-execution button.

A third aspect of the present invention provides a method for an information processing apparatus, which performs a predetermined series of processes to document information in cooperation with an external device according to a job flow, which expresses a plurality of processes performed to document information, the method comprising: (a) displaying an operation designation input screen that inputs an operation designation for the job flow, a rule information input screen that inputs rule information serving as information which defines rules for conditions of cooperation with the external device, and a determining button, which is to be designated when inputting of the operation designation and the rule information has been terminated and an input result has been determined; (b) deciding, when the determining button is designated, whether an operation for the job flow can be executed by the operation designation; and (c) when it is decided that an operation cannot be executed in (b), displaying on the display a reason why the operation cannot be executed, and displaying a re-execution button, which is to be designated when the operation is re-executed.

According to the information processing apparatus of the invention and the storage medium of the invention in which an information processing program is stored, when a job flow obtained by expressing as a single series of processes multiple processes performed to document information is transmitted to an external device, the external device performs a series of processes to the document information in order to store and execute a series of processes, thus enabling information processing apparatus to perform one predetermined series of processes to the document information in cooperation with the external device. An operation designation input screen for inputting an operation designation for the job flow, and a rule information input screen for inputting rule information serving as information which defines rules for conditions of cooperation with the external device are displayed by the display; a determining button, which is to be designated when inputting of the operation designation and the rule information has been terminated and an input result has been determined is displayed on the display; when the determining button is designated, it is decided whether an operation for the job flow can be executed by the operation designation; when it is determined that an operation cannot be executed, a reason why the operation cannot be executed is displayed by the display; and the display is controlled in such a way that when an operation is re-executed, a re-execution button designated is displayed by the display. For this reason, conditions within the system start to change once inputting of an operation designation for a job flow has been terminated. Even when an operation dependent on the input operation designation cannot be executed, the reason why the operation cannot be executed can be easily recognized by referring to the display contents of the display. As a result, beneficial results are obtained in so far thus measures can be easily adopted to counter the fact that an operation dependent on the operation designation cannot be executed and also that once such measures have been adopted it is possible to re-execute the operation for the job flow merely by designating the re-execution button.

### BRIEF DESCRIPTION OF THE DRAWINGS

Embodiments of the present invention will be described in detail based on the following figures, wherein:

FIG. 1 is a schematic diagram of a document-shared network system according to an embodiment of the invention;

FIG. 2 is a diagram for explaining an outline of the document-shared network system;

FIG. 3 is a block diagram showing a configuration of a compound machine;

FIG. 4 is a block diagram showing a configuration of a control device;

FIG. 5 is a diagram for explaining an example of a rule which can be generated by arbitrarily combining an input system plug-in, a processing system plug-in, and an output system plug-in;

FIGS. 6A and 6B include a flowchart showing a flow of processes of a rule setting process program according to an embodiment;

FIG. 7 is a diagram showing a rule-setting screen;

FIG. 8 is a diagram showing a job flow cooperation setting screen;

FIG. 9 is a diagram showing an operation re-execution screen; and

FIG. 10 is a flow chart showing a procedure performed when a CPU of the control device executes processes according to a rule.

### DETAILED DESCRIPTION OF THE INVENTION

Embodiments of the present invention will be described below with reference to the accompanying drawings.

[System Configuration]

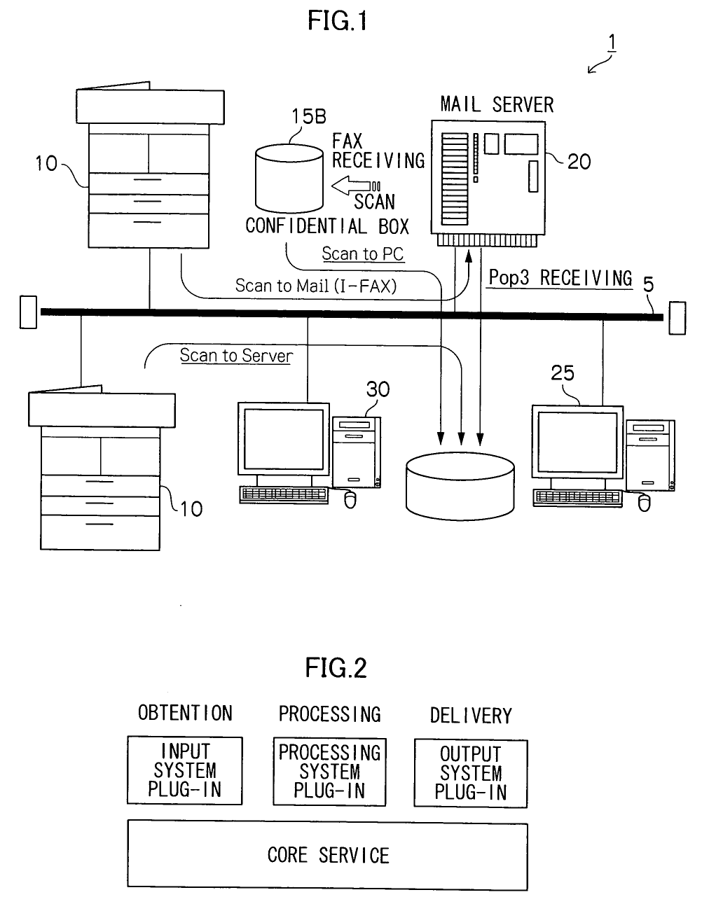

FIG. 1 is a schematic diagram of a configuration of a document-shared network system 1 according to an embodiment of the invention.

The document-shared network system 1 includes multiple compound machines 10 each having a printer function, a scanner function, and a facsimile function, a mail server 20 which performs transmission/reception of electronic mail, multiple terminal devices 25; and a control device 30 which obtains a document from an source of obtention and performs a predetermined processing to the document, and then, controls delivery to a predetermined delivery destination. The type of document mentioned here is mainly image data related to a document. However, the document may include text data depending on conditions of processing, and is not limited to specific data.

The compound machines 10, the mail server 20, each terminal device 25, and the control device 30 are connected to each other through a network 5. Devices such as a printer, a scanner, and a FAX may also be connected to the network 5.

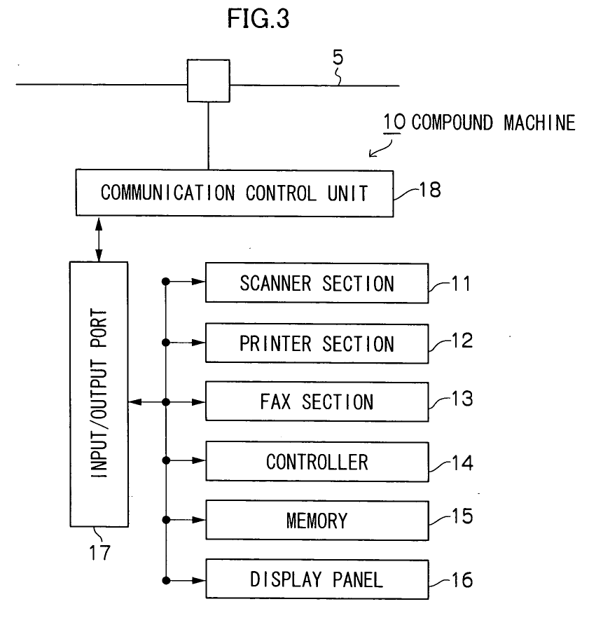

FIG. 2 is a diagram for explaining an outline of processes of the document-shared network system 1. Although the compound machine 10, the mail server 20, and the terminal devices 25 are connected to each other through the network 5, in general, each of these components is independently operated. Therefore, within the document-shared network system 1, the control device 30 sets a source of obtention, a processing method, and a delivery destination and automates/stylizes a series of processes including obtention of a document, processing and delivery, thus providing a core service.

In this context, a “rule” is defined as something that automates/stylizes a series of processes. Setting of a rule will be described later. An application program provides specific functions of obtention, a processing method, and delivery, and these functions are respectively called an input system plug-in, a processing system plug-in, and an output system plug-in.

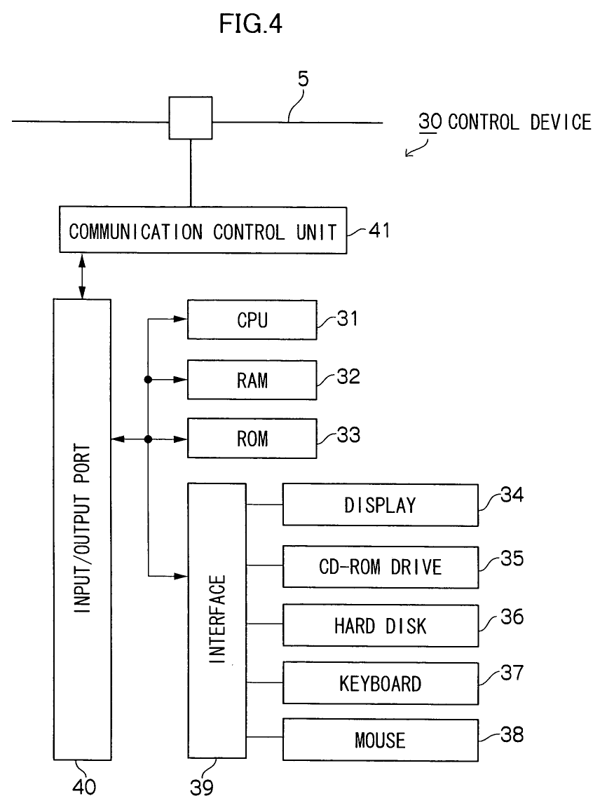

FIG. 3 is a block diagram showing the configuration of the compound machine 10.

The compound machine 10 can provide the functions of the input system plug-in and the output system plug-in. The compound machine 10 also includes a scanner section 11 which reads an image recorded on an original document: a printer section 12 which records an electrostatic latent image on a photosensitive member, develops the electrostatic latent image by using monochrome toners or color toners, and transfers the developed image onto a sheet of recording paper to output the recording paper; and a FAX section 13 which transmits and receives a facsimile telegram.

The compound machine 10 further includes a controller 14 which controls all the components; a memory 15 which stores data including image data read by the scanner section 11, image data received through the network 5, and data of a FAX telegram received; a display panel 16 which displays an operation screen having icons, and inputs operation information dependent on contact with the icons; an input/output port 17 for inputting/outputting data, and a communication control unit 18 which communicates with the devices connected to the network.

The scanner section 11, the printer section 12, the FAX section 13, the controller 14, the memory 15, the display panel 16, and the input/output port 17 are all connected to each other through a bus. The input/output port 17 is connected to the network 5 through the communication control unit 18. The scanner section 11 may be incorporated as a part of the FAX section 13.

The mail server 20 can provide the functions of an input system plug-in and an output system plug-in, and serves as a server, which can transmit and receive electronic mail from the terminal devices 25 connected to the network 5.

The terminal devices 25 can provide the functions of an input system plug-in, a processing system plug-in, and an output system plug-in, and may be a personal computer. The terminal device 25 transmits and receives electronic mail to and from an external destination or source through the mail server 20, holds documents in a file folder, or performs predetermined image processing on a document.

The control device 30 executes a series of processes including setting of rules, obtention of documents based on the rules, and processing and delivery of documents. The control device 30 may act as a processing system plug-in.

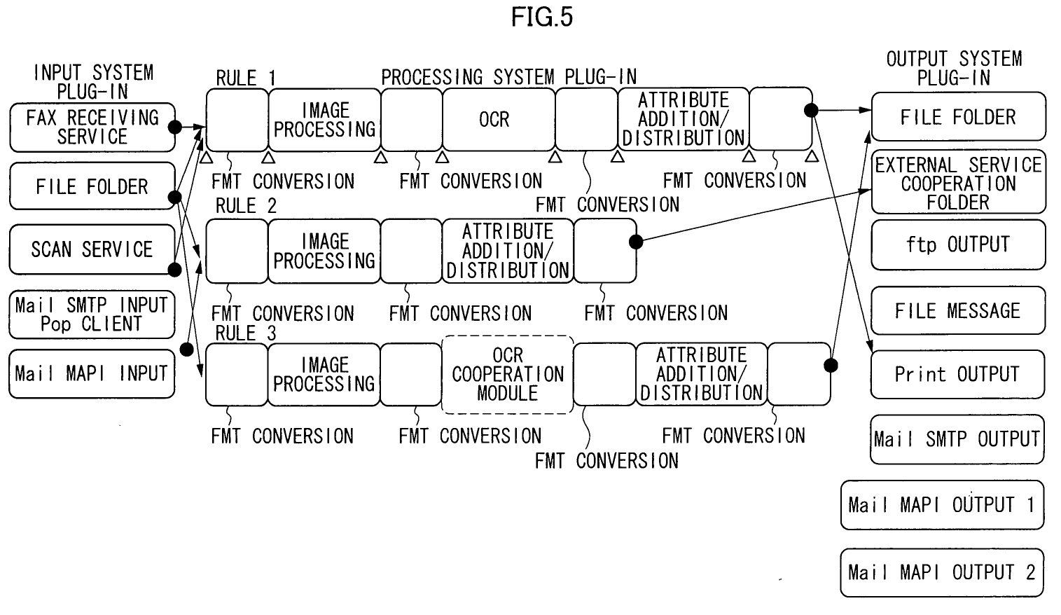

FIG. 4 is a block diagram showing a configuration of the control device 30.

The control device 30 includes a CPU (Central Processing Unit) 31 which controls all the components of the control device 30, a RAM 32 serving as a work area in which data is temporarily stored, a ROM (Read Only Memory) 33 which stores control programs and the like for the CPU 31, a display 34 which displays a rule-setting screen or the like for setting rules, and a CD-ROM drive 35.

The control device 30 further includes a hard disk drive 36 which stores and reads a program for automating/stylizing a series of processes including obtention of a document, processing and delivery of documents, an application program functioning as a processing system plug-in, predetermined data, and the like; a keyboard 37 for inputting a text, codes, and the like; a mouse 38 serving as a pointing device; an interface 39 to which these components are connected; an input/output port 40, and a communication control unit 41.

The CPU 31, the RAM 32, the ROM 33, and the interface 39 are connected to the communication control unit 41 which communicates with other devices such as the compound machine 10 which is itself connected to the network 5 through the input/output port 40.

The keyboard 37 is used when information designated by an operator is directly input onto various setting screens displayed on the display 34. The mouse 38 is used when an object displayed is selected, or when the contents of a setting designation are input onto various setting screens displayed on the display 34.

[Example of a Rule]

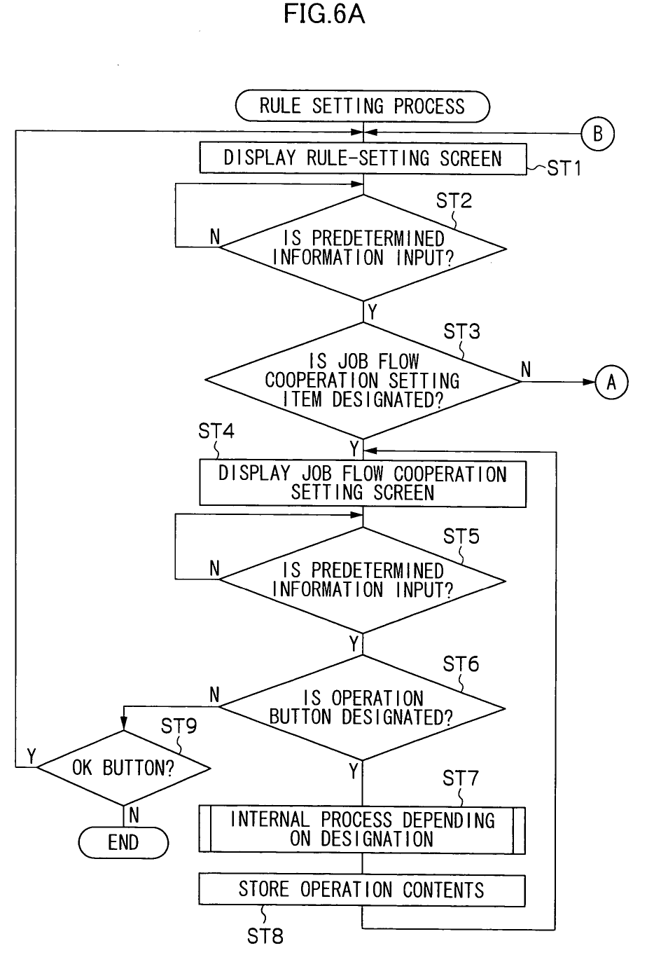

FIG. 5 is a diagram for explaining an example of a rule which can be generated by arbitrarily combining by means of the control device 30 an input system plug-in, a processing system plug-in, and an output system plug-in.

For example, “rule 1” defines a process in which a document is obtained from multiple input system plug-ins (a FAX receiving service, a file folder, and a scan service), subjected to processing by a plurality of processing system plug-ins (image processing, optical character recognition, and attribute addition/distribution) and in which a document which has been subjected to such processing is delivered to multiple output system plug-ins (file folder and print output). “Rule 2” defines a process in which a document is obtained from a file folder or from a Mail_MAPI input, subjected to image processing and attribute addition/distribution, and in which a document which has been subjected to such processing is delivered to an external service cooperation folder. “Rule 3” defines a process in which a document is obtained from a file folder and subjected to image processing, processing of an OCR cooperation module, and attribute addition/distribution and in which a document subjected to such processing is distributed to a file folder. Moreover, before and after each processing system plug-in, “Rules 1 to 3” perform the format (FMT) conversion essential for the next step of processing.

In this case, as the input system plug-ins, as shown in FIG. 5, for example, a FAX receiving service, a file folder, a scan service, a Mail_SMTP input, a POP client, a Mail_MAPI input, and the like are known. A confidential box shown in FIG. 1 also corresponds to the input system plug-ins.

Among processing system plug-ins, image processing, OCR, attribute addition/distribution and, an OCR cooperation module, are known.

Examples of known output system plug-ins are a file folder, an external service cooperation folder, an ftp output, a file message, a Mail_SMTP output, and a Mail_MAPI output. The plug-in for the input system, the processing system, and the output system are not limited to the above-mentioned plug-ins.

In the document-shared network system 1 according to this embodiment, after a series of processes extending from obtention to delivery have been defined as rules, the series of processes can be repeatedly executed according to this definition. Moreover, once the definition has been completed, when information (job flow) for executing a series of processes is delivered to multiple devices connected by the network enable the devices to store and execute the information, the multiple devices are capable of performing the series of processes in cooperation with each other.

This configuration is to store in advance the job flow in the devices connected through out the network, and to execute the job flow. For this reason, the document-shared network system 1 makes it possible to perform the various operations for a job flow. Specifically, when a new job flow is formed, the job flow is delivered to, and stored in, an appropriate device, or alternatively the job flow which has already been stored in devices is updated or deleted.

In the document-shared network system 1, after designations of various operations for a job flow have been input, and after the definition has been completed, operations depending in the input designations for the job flow are reflected in a corresponding device. This is because all the settings are completed once the definition of the rules has been determined. Until the definition is determined, operation contents for a job flow may be changed, and on occasions, the job flow itself may be changed. The reason for this is that it is considerably disadvantageous in terms of a processing load if changing conditions are reflected in each device every time that a change occurs.

In these circumstances, the time lag between a time when a designation of an operation for a job flow is input and a time when the definition is completed may not be short. For this reason, during the time lag, for example, a power supply of a device corresponding to a location where a job flow to be operated is stored may be turned off, an account having a right to access a device may be changed, or a user may erroneously delete a folder serving as a location where the job flow is delivered, thus on occasions causing a radical change in conditions within the system.

In these circumstances, because of the changes in conditions, it becomes impossible to reflect the operations for the job flow into the various devices. In the worst case, the information related to the operations for the job flow may itself be lost.

In order to cope with this problem, in the document-shared network system 1 according to the embodiment, it is decided whether, upon completion of the definition, the operations for a job flow can be executed. When the operations cannot be executed, the document-shared network system 1 clearly shows information related to this to a user.

[Operation of Document-Shared Network System 1]

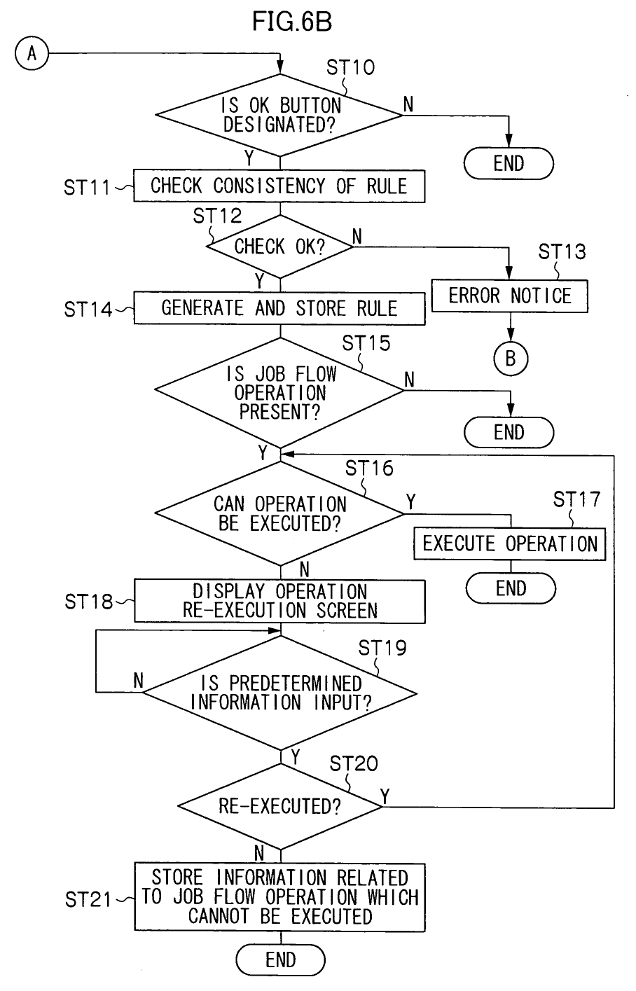

Operations performed when, in accordance with the document-shared network system 1 according to the embodiment, rules described above, are newly formed or existing rules are edited, will be described below with reference to FIGS. 6A and 6B. FIGS. 6A and 6B include a flow chart showing a flow of processes of a rule-setting process program executed by the CPU 31 within the control device 30. The program has been stored in advance in a predetermined region of the hard disk drive 36.

In step ST1 in FIG. 6A, a predetermined rule-setting screen 150 is displayed on the display 34. In the next step ST2, an input of predetermined information is awaited.

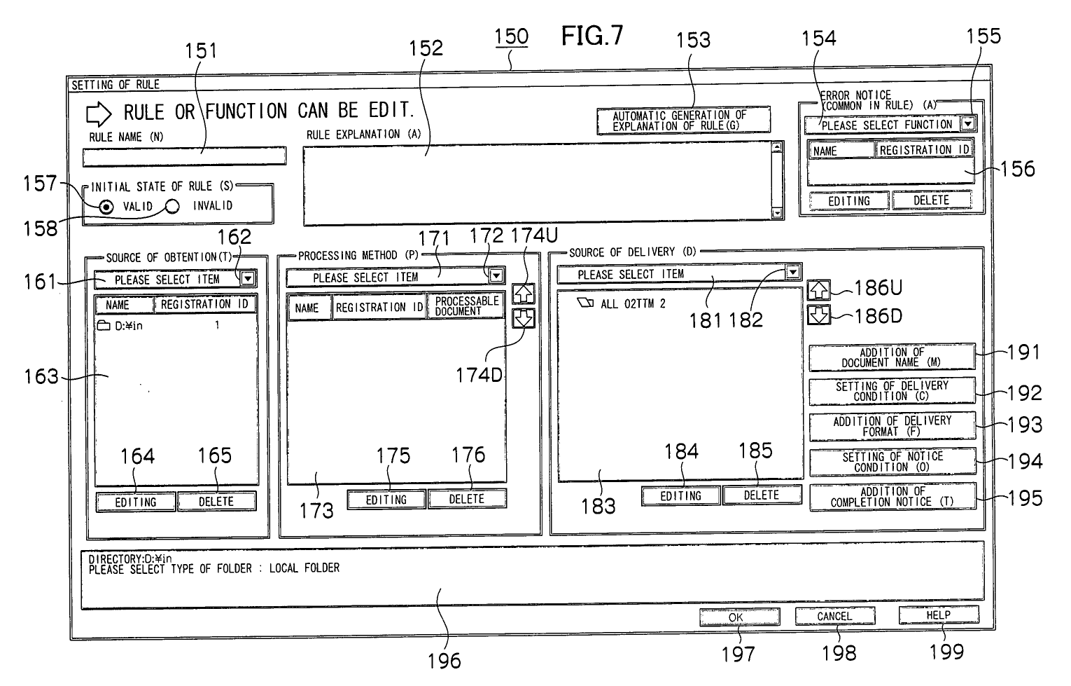

FIG. 7 shows a display state of the rule-setting screen 150 displayed on the display 34 by the means of process in step ST1.

As shown in FIG. 7, the rule-setting screen 150 according to the embodiment has a rule name box 151 for inputting a rule name, a rule explanation box 152 for inputting a rule explanation, an explanation automatic generation button 153 for designating automatic generation of a rule explanation, an error notice drop-down list 154, an error notice drop-down list button 155, an error notice list box 156, a rule initial state validity setting button 157, and a rule initial state invalidity setting button 158.

The rule name box 151 is to display a name of a rule to be newly formed or edited. During the formation of a new rule, the rule name box 151 remains blank, and a rule name is an essential input item. The rule explanation box 152 displays an explanatory text of a rule name displayed in the rule name box 151. A rule explanation is arbitrarily input into the rule explanation box 152.

The explanation automatic generation button 153 is a button which automatically generates a rule explanation on the basis of a source of obtention which has been input, a processing method, and the contents of the plug-ins of a delivery destination. A rule explanation generated when the explanation automatic generation button 153 is clicked is displayed in the rule explanation box 152.

When the error notice drop-down list button 155 is clicked, the error notice drop-down list 154 displays at least one of error notice functions installed. When one error notice function is selected from the error notice drop-down list 154, a name and a registration ID specifying the error notice function are displayed in the error notice list box 156.

In this case, the rule-setting screen 150 includes, as components related to a source of obtention, a source of obtention drop-down list 161, a source of obtention drop-down button 162, a source of obtention list box 163, a source of obtention editing button 164, and a source of obtention deletion button 165.

The source of obtention drop-down list 161 displays by default a “please select item”. However, when the source of obtention drop-down button 162 is clicked, at least one input system plug-in installed (for example, a file folder or the like) and a ready-made (a recommended menu) or an item (referred to hereinafter as a “job flow cooperation setting item”) designated when a job flow cooperation setting screen (to be described later) is displayed are displayed.

When one input system plug-in from selected in the source of obtention drop-down list 161, a setting dialogue of the input system plug-in is displayed.

The source of obtention list box 163 displays an input system plug-in the setting of which is normally terminated during the setting dialogue described above. More specifically, the source of obtention list box 163 displays the name of the input system plug-in, which has been set, and an icon representing the input system plug-in. In the source of obtention list box 163, at least one input system plug-in must be displayed until the OK button 197 is clicked.

The source of obtention editing button 164 is a button for designating, setting and editing of the input system plug-in selected from at least one input system plug-in displayed in the source of obtention list box 163. An input system plug-in within the source of obtention list box 163 may, when desired, be selected and double-clicked. The source of obtention deleting button 165 is a button for designating deletion of an input system plug-in selected from the at least one input system plug-in displayed in the source of obtention list box 163.

The rule-setting screen 150 includes, as components related to a processing method, a processing method drop-down list 171, a processing method drop-down button 172, a processing method list box 173, processing method order change buttons 174U and 174D, a processing method editing button 175, and a processing method deleting button 176.

The processing method drop-down list 171 displays by default a “please select item”. When the processing method drop-down button 172 is clicked, at least one processing system plug-in, which has been installed (for example, image processing or an optical character recognition process (OCR)) and “ready-made” are displayed. When one processing system plug-in is selected from the processing method drop-down list 171, a setting dialogue of the processing system plug-in is displayed.

The processing method list box 173 displays the processing system plug-in the setting of which has been terminated a normal fashion during the setting dialogue. More specifically, the processing method list box 173 displays the name of the set processing system plug-in and an icon representing the processing system plug-in.

The processing method order change buttons 174U and 174D are buttons for changing an execution order of processing system plug-ins after multiple processing system plug-ins have been displayed in the processing method list box 173. For example, each time that the processing method order change button 174U is clicked, the processing method order change button 174U raises one by one the priority order of the processing system plug-in selected in the processing method list box 173. On the other hand, each time that the processing method order change button 174D is clicked, the processing method order change button 174D lowers one by one the priority order of the processing plug-in selected in the processing method list box 173.

The processing method editing button 175 and the processing method deleting button 176 perform respectively the same operations as those of the source of obtention editing button 164 and the source of obtention deletion button 165, thus making it possible to designate editing and deletion of a processing system plug-in displayed in the processing method list box 173.

The rule-setting screen 150 includes, as components related to a delivery destination, a delivery destination drop-down list 181, a delivery destination drop-down button 182, a delivery destination list box 183, a delivery destination editing button 184, a delivery destination deleting button 185, and delivery destination order change buttons 186U and 186D.

The delivery destination drop-down list 181 displays by default a “please select item”. When the delivery destination drop-down button 182 is clicked, at least one output system plug-in, which has been installed (for example, a file folder, a print output, or a mail SMTP output) and “ready-made” are displayed. When one output system plug-in is selected from the delivery destination drop-down list 181, a setting dialogue of the output system plug-in is displayed.

The delivery destination list box 183 displays the name of the set output system plug-in and an icon representing the output system plug-in. More specifically, when setting in the setting dialogue has been terminated in a normal fashion, the delivery destination list box 183 displays in a tree delivery conditions of the output system plug-in, delivery formats, notice conditions, and methods of notice.

The delivery destination editing button 184 is a button for editing the contents of delivery conditions, a delivery format, a method of notice, and notice conditions of the output system plug-in displayed on the delivery destination list box 183. The delivery destination deleting button 185 is a button for designating a selected output system plug-in to be removed from a rule. In circumstances where the output system plug-in is not selected, the delivery destination deleting button 185 cannot be clicked.

The delivery destination order change buttons 186U and 186D are buttons for changing an execution order of output system plug-ins after multiple output system plug-ins have been displayed. Each time that the delivery destination order change button 186U is clicked, the order of priority of the output system plug-in rises one by one. Each time that the delivery destination order change button 186D is clicked, the order of priority of the output plug-in drops one by one.

The rule-setting screen 150 further includes, as components related to an output system plug-in, a document name adding button 191 for adding a document name to the delivery destination list box 183, a delivery condition setting button 192, a delivery format adding button 193, a notice condition setting button 194, and a completion notice button 195.

The rule-setting screen 150 further includes a setting contents display box 196, an OK button 197 for generating a rule, which conforms to contents of items, which have been input, a cancellation button 198 for canceling an input process, and a help button 199.

The setting contents display box 196 displays the setting contents of a plug-in selected from among the plug-ins displayed on the list boxes 163, 173, and 183 with the mouse 38 shown in FIG. 4. For example, as shown in FIG. 7, when a user selects with the mouse 38 “directory D:¥in”, the setting contents display box 196 displays, as setting contents of the “directory D:¥in”, “please select type of folder: local folder” as setting contents of the “directory D: ¥in”. More specifically, the setting contents display box 196 displays a state in which the “directory D: ¥in” requires selection of a type of a folder.

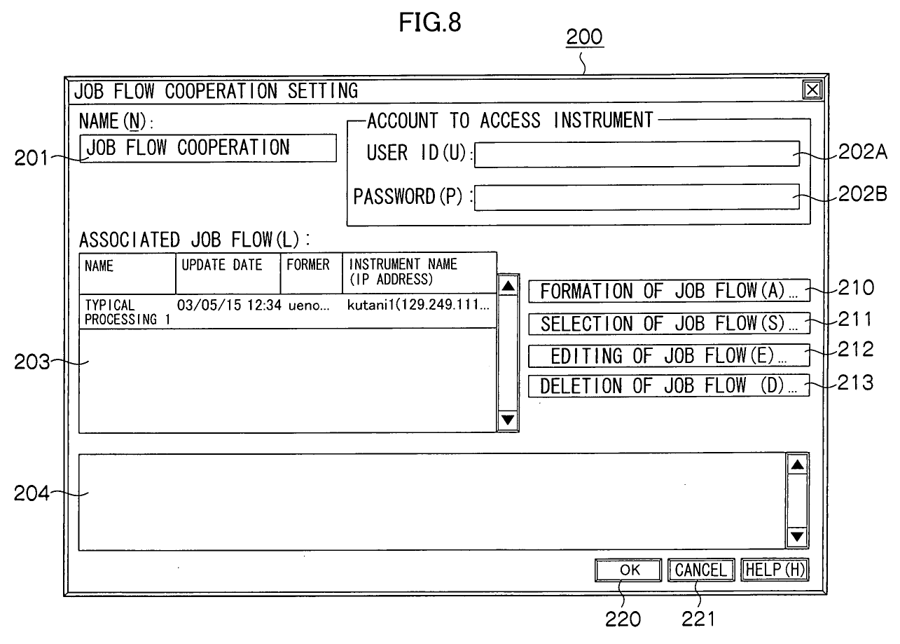

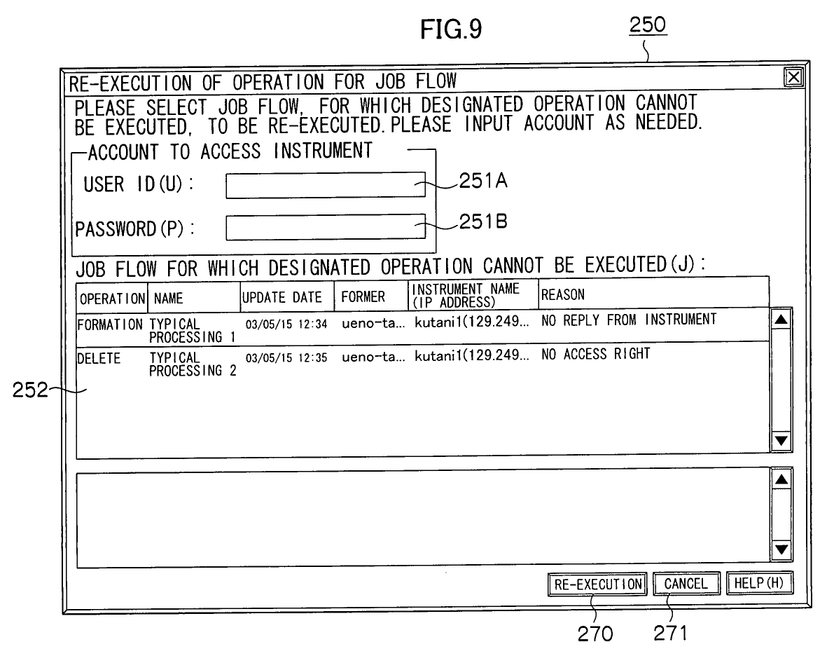

The OK button 197 designates a start of a process of deciding whether or not a rule has consistency. When the rule has consistency, the OK button 197 designates a rule to be generated on the basis of the contents of the list boxes 163, 173, and 183 representing respectively the sources of obtention, processing methods, and delivery destinations. On the other hand, the cancellation button 198 designates formation of a new rule or the cancellation of an editing process of a rule. The help button 199 shown in FIG. 7 is designated when a query is raised about an operation method of the rule-setting screen 150 or the like. Since the help button 199 is not related to the invention to avoid complication, an explanation of the help button 199 will be omitted. In addition, although help buttons are also displayed on various screens (to be described later) (a job flow cooperation setting screen shown in FIG. 8 and an operation re-execution screen shown in FIG. 9), these help buttons have likewise been omitted in the course of the following explanation.

When the rule-setting screen 150 as described above is displayed on the display 34, after the setting of various pieces of information required to generate a rule has been completed, a user designates with the mouse 38 the OK button 197, or designates with the mouse 38 the cancellation button 198 to cancel formation of a new rule or an editing process of a rule. Alternatively, a user designates with the mouse 38 the source of obtention drop-down button 162, displays the job flow cooperation setting item described above on the source of obtention drop-down list 161, and then designates with the mouse 38 the corresponding item. In this manner, the determination in step ST2 is affirmative, the routine continues to step ST3.

In step ST3, it is decided whether or not the item designated on the rule-setting screen 150 was a job flow cooperation setting item. When the determination in step ST3 is affirmative, the routine continues to step ST4.

In step ST4, a predetermined job flow cooperation setting screen 200 is displayed on the display 34. In step ST5, inputting of predetermined information is awaited.

FIG. 8 shows a display state of the job flow cooperation setting screen 200 displayed on the display 34 by means of the process in step ST4.

Also as shown in FIG. 8, according to the embodiment, the job flow cooperation setting screen 200 has a processing name box 201 for inputting a name of processing performed on the screen, an user ID box 202A and a password box 202B for user account information required to access a device (instrument)in which a job flow has been stored, a related job flow list box 203 for displaying information related to a job flow associated with a rule, which is already in place, and a job flow list box 204 for displaying as a list job flows, which have already been formed.

In the processing name box 201, “job flow cooperation” is displayed by default. However, a user can change this name into an arbitrary name. Moreover, in the related job flow list box 203, items of information including the name of a job flow associated with the currently set rule, an update data, a former, and an instrument name (IP address) representing a storage device of the job flow are displayed as a list for each job flow.

The job flow cooperation setting screen 200 includes, as buttons for inputting operation designations for a job flow, a job flow forming button 210, a job flow selection button 211, a job flow editing button 212, and a job flow deletion button 213.

The job flow forming button 210 is designated when a new job flow is formed. The job flow selection button 211 is designated when a process such as the setting of an association between a job flow already formed and a rule, already in place, or the cancellation of an association, is performed. The job flow editing button 212 is designated when the description contents of the job flow, which has been formed, are edited. The job flow deletion button 213 is designated when a job flow, which has been formed, is deleted. The buttons for inputting operation designations for these job flows are hereinafter normally described as “operation buttons”.

On the other hand, the job flow cooperation setting screen 200 includes an OK button 220 designated when processing on the job flow cooperation setting screen 200 is completed, and a cancellation button 221 designated when processing on the job flow cooperation setting screen 200 is canceled.

When the job flow cooperation setting screen 200 is displayed on the display 34, as and when required a user uses the keyboard 37 and the mouse 38 to input into the user ID box 202A and into the password box 202B information about his or her own account which has already been provided and by means of a pointing operation performed with the mouse 38 designates a desired operation button. The user also designates the OK button 220 by means of a pointing operation performed with the mouse 38 when various operations for a job flow are ended to end processing on the job flow cooperation setting screen 200, and designates the cancellation button 221 by a pointing operation performed with the mouse 38 when processing on the job flow cooperation setting screen 200 is canceled.

When any operation button or any one of the OK button 220 and the cancellation button 221 is designated, the determination in step ST5 is affirmative, and the routine continues to step ST6.

In step ST6, it is decided whether or not any operation button has been designated on the job flow cooperation setting screen 200. When the determination in step ST6 is affirmative, the routine continues to step ST7 and as explained below, internal processing of the control device 30 is executed on the basis of the designated operation button.

For example, when the designated operation button is the job flow forming button 210, a screen for forming a new job flow is displayed on the display 34. According to this, a user forms a job flow on the screen. In these circumstances, the user inputs various items of information, including the name of the job flow formed, the person responsible, and an instrument name (IP address) representing a device in which the job flow has been stored.

When the designated operation button is the job flow selection button 211, information related to a job flow associated with a rule, which is already in place is displayed in the form of a list in the related job flow list box 203 and all job flows, which have been formed are also displayed in the form of a list in the job flow list box 204. Furthermore, a function related to input, processing, or output desired by a user may be designated, and information about job flows related to such functions may be displayed in the form of a list in the related job flow list box 203. According to this, a user performs an operation to select from among the job flows displayed in the job flow list box 204 a job flow, which has recently been associated with a rule, which is already in place, or alternatively to cancel association of a job flow which has already been associated with a rule displayed in the related job flow list box 203.

On the other hand, when the user edits the job flow associated with a rule currently in place, after the user selects a job flow from the job flows displayed in the related job flow list box 203 and designates the job flow, the user designates the job flow editing button 212. According to this, the CPU 31 displays a screen for editing on the display 34 the job flow selected. According to this, the user edits the job flow displayed on the screen.

When the user deletes a job flow associated with a rule currently in place, after the user selects the job flow from among the job flows displayed in the related job flow list box 203 and designates the job flow, the user designates the job flow deletion button 213. Based on this, the CPU 31 deletes (erases) the job flow selected.

An operation for a job flow dependent on the designated operation button is performed within the control device 30, and the operation contents are reflected in a device in which the operated job flow was stored when the OK button 197 set on the rule-setting screen 150 was designated.

When the internal processing based on the designated operation button has been terminated, in the next step ST8, information representing the operation contents of the job flow which was performed in step ST7 is stored in a predetermined region of the RAM 32, and the routine returns to step ST4.

In step ST8, information representing the name of the job flow to be operated and the type of the operation for the job flow is stored.

On the other hand, when the determination in step ST6 is negative, the routine continues to step ST9. In step ST9, it is decided whether or not the OK button 220 has been designated on the job flow cooperation setting screen 200. When the determination in step ST9 is affirmative, the procedure returns to step ST1. When the determination in step ST9 is negative, the cancellation button 221 is deemed to have been designated on the job flow cooperation setting screen 200, and the rule setting process program is terminated.

On the other hand, when the determination in step ST3 is negative, the routine continues to step ST10 to decide whether or not the button designated on the rule-setting screen 150 was the OK button 197. When the determination in step ST10 is affirmative, the routine continues to step ST11.

In step ST11, on the basis of data formats which can be input or output by plug-ins such as the input system plug-ins, the processing system plug-ins, and the output system plug-ins, a decision is made on the existence or otherwise of differences between formats of plug-ins connected back and forth, and a check is thus made as to whether or not a rule set by a user on the rule-setting screen 150 shown in FIG. 7 has been applied.

For example, consistency between an output data format of an input system plug-in displayed in the source of obtention list box 163 and an input data format of the processing system plug-in displayed on the processing method list box 173 is decided. No problem arises when these data formats are consistent with each other. Similarly, consistency between an output data format of the processing system plug-in displayed in the processing method list box 173 and an input data format of the output system plug-in displayed in the delivery destination list box 183 is decided. No problem arises when these data formats are consistent with each other.

In the next step ST12, it is decided whether or not the check result in step ST11 has no problem. When the determination in step ST12 is negative, i.e., when any one of the output/input data formats of the plug-ins is not consistent with other data formats, the routine continues to step ST13 to draw the error to the attention of a user and to urge the user to correct the rule, and the routine returns to step ST1.

When the determination in step ST12 is affirmative, the routine continues to step ST14, and a source of obtention, a processing method, and a delivery destination are set on the basis of information input through the rule-setting screen 150 to generate a rule which defines a series of processes, extending from the obtention of a document, through processing to delivery. After this rule has been stored in a predetermined region of the hard disk drive 36, or in an external storage medium, the routine continues to step ST15.

In step ST15, it is decided whether the information representing the operation contents for the job flow has been stored in the predetermined region of the RAM 32 during the process in step ST8, and on this basis, it is then decided whether or not an operation for the job flow needs to be performed. When the determination in step ST15 is negative, the rule setting process program is terminated. When the determination in step ST15 is affirmative, the routine continues to step ST16.

In step ST16, it is decided, with respect to all the job flows associated with a rule generated, whether the operation contents for job flows can be reflected in an instrument having an instrument name (IP address) representing the device in which the job flow has been stored. As the decision, for example, a decision about whether the power supply of a device corresponding to a location where a job flow to be operated is stored is turned on, a decision about whether an account input on the job flow cooperation setting screen 200 is consistent with an account having the right to access a device to be accessed, a decision about whether a folder serving as a location where the job flow is stored is present, a decision about whether the device serving as a location where the job flow is stored is engaged, and the like can be exemplified.

When the determination in step ST16 is affirmation, the routine continues to step ST17. With respect to all the job flows associated with a rule generated, the operation contents for the job flows are reflected in an instrument having an instrument name representing a device in which the job flows has been stored, and the rule setting process program is terminated.

When an operation for the job flow is a freshly established operation for forming a job flow, the reflection of the operation contents in step ST17 is performed by delivering and storing the job flow formed in step ST17 to/in a device designated as a device in which the job flow has been stored. When the operation for the job flow is the editing of job flow, the reflection is performed by delivering and storing (updating) the job flow edited in step ST7 to/in the device designated as the device in which the job flow is stored. In addition, when the operation for the job flow is the deletion of job flow, the reflection is performed by deleting (erasing) the job flow from the device designated as the device in which the job flow is stored.

On the other hand, when the determination step ST16 is negative, the routine continues to step ST18 to display a predetermined operation re-execution screen 250 on the display 34. In the next step ST19, inputting of predetermined information is awaited.

FIG. 9 shows a display state of the operation re-execution screen 250 displayed on the display 34 by the process in step ST18.

As is also shown in FIG. 9, on the operation re-execution screen 250 according to the embodiment are displayed a message urging a user to select, from among job flows which cannot be operated, a job flow to be re-executed, and, as and when required, a message urging the input of account information. Also displayed on the operation re-execution screen 250 according to the embodiment are a user ID box 251A and a password box 251B for inputting account information, and an unoperated job flow list box 252 for displaying, in the form of a list, information about job flows which can not be operated.

The unoperated job flow list box 252 shows pieces of information including the type of an operation related to the job flow which cannot be operated, the name, update date, and the persons responsible for forming of the job flow, an instrument name (IP address) representing a device in which the job flow is stored, and a reason why the job flow cannot be operated as list.

The operation re-execution screen 250 also includes a re-execution button 270 to be designated when an operation (reflection on a device corresponding to the operation) for the job flow is re-executed and a cancellation button 271 to be designated when processing on the operation re-execution screen 250 is to be canceled.

When the operation re-execution screen 250 is displayed on the display 34, a user performs an operation for coping with the reason with reference to the reason why the job flow cannot be operated and which is displayed in the unoperated job flow list box 252 with respect to the job flow to be re-executed. As the operation, turning on of the power supply when the power supply of the device corresponding to the device corresponding to a location where the job flow to be re-executed is stored is in an off state, inputting of account information having the right to access the user ID box 251A and the password box 251B when an account input on the job flow cooperation setting screen 200 is not consistent with an account having the right to access a device to be accessed, formation of a folder when a folder serving as a location where a job flow is stored is not present, canceling of a engaged state of the device serving as the location where the job flow is stored when the device is engaged, or the like can be exemplified.

After an operation for coping with the reason why the job flow cannot be operated, a user selects a job flow for which the operation is to be re-executed from job flows displayed in the unoperated job flow list box 252, designates the job flow, and then designates the re-execution button 270 by means of a pointing operation using the mouse 38.

On the other hand, when the user re-executes the operation at a later stage because the user wants to use a device on which the operation for the job flow cannot be reflected in another application, because the user personally wants to perform another operation, and the because the coping with the device cannot be immediately completed, the cancellation button 271 is designated by means of a pointing operation performed with the mouse 38.

When the re-execution button 270 or the cancellation button 271 is designated, the determination in step ST19 is affirmative, and the routine continues to step ST20.

In step ST20, it is decided whether the designated button is the re-execution button 270. When the determination in step ST20 is affirmative, the routine returns to step ST16. When the determination in step ST20 is negative, it is regarded that the cancellation button 271 is designated, and the routine continues to step ST21.

In step ST21, with respect to the job flow which cannot be operated, pieces of information including the name of the job flow (corresponding to “specific information” in the invention), operation contents for the job flow, and the reason why the job flow cannot be operated are stored in a predetermined region of the hard disk drive 36. Thereafter, the rule setting process program is terminated.

The pieces of information stored in step ST21 of the rule setting process program are read from the hard disk drive 36 when a designation of execution of reflection of the operation for the job flow on the devices at an arbitrary timing is input by a user. The operation re-execution screen 250 having the same format as that in FIG. 9 is displayed on the display 34 again, and the same operations as those in steps ST16 to ST20 are performed to reflect the operation for the job flow on the devices.

Steps ST1 and ST4 of the rule setting process program correspond to step (a) of the second aspect of the invention, step ST16 corresponds to step (b) of the invention, step ST18 corresponds to steps (c), (d), and (f) of the invention, and step ST21 corresponds to step (e) of the invention.

[Execution of Rule]

On the basis of a rule stored in the hard disk drive 36 or an external storage medium, the control device 30 obtains a document from the document-shared network system 1 and processes a document, and then executes one series of processes until the document is delivered to a predetermined delivery destination.

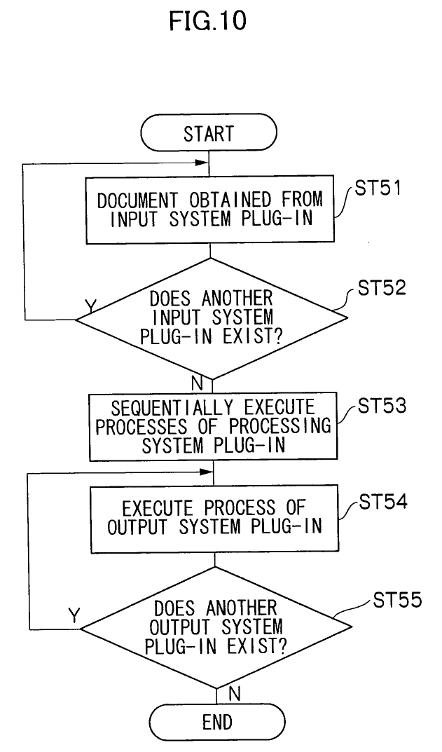

FIG. 10 is a flow chart showing a procedure performed by the CPU 31 of the control device 30 executing processes according to the rule. More specifically, the CPU 31 of the control device 30 executes the processes from the following step ST51 to step ST55. An explanation will be performed below with reference to rule 1 shown in FIG. 5.

In step ST51, a document is obtained from an input system plug-in (for example, a FAX receiving service) set as a “source of obtention” of a rule, and the routine continues to step ST52.

In step ST52, it is decided whether other input system plug-ins which have not been executed remain in the “source of obtention” set by the rule. When another input system plug-in (for example, a file folder or a scan service) which has not yet been executed remains, the routine returns to step ST51. When no other input system plug-in remains, the routine continues to step ST53. In this manner, the processes in step ST51 and step ST52 are repeated, and thus documents are obtained from all the input system plug-ins.

In step ST53, processes of a processing system plug-in set as a “processing method” of the rule are sequentially executed. In the case of rule 1, after image processing such as edge enhancement and skew correction and optical character recognition (OCR), attribute addition/distribution (attribute dependent on the delivery destination in the next step is added to a document) is performed.

In these circumstances, necessary format conversion is performed before various processes such as image processing, OCR, and attribute addition/distribution. Furthermore, after the process of attribute addition/distribution, format conversion is performed to cope with the next delivery destination. This format conversion may be automatically executed on the basis of the set processing system plug-in or may be executed by manual setting by an operator. After these processes are completed, the routine continues to step ST54.

In step ST54, the document subjected to the process in step ST53 is delivered to an output system plug-in (for example, a file folder) set as a “delivery destination” according to delivery conditions. When an attribute representing the delivery destination is added to the document, the delivery destination may be specified on the basis of the attribute. After a predetermined notice is performed according to notice conditions and the notice method, the routine continues to step ST55.

In step ST55, it is decided whether the “delivery destination” set by the rule includes another output system plug-in, which has not been executed. When the “delivery destination” includes another output system plug-in (for example, Print output) which has not been executed, the routine returns to step ST54. When the “delivery destination” does not include another output system plug-in, these processes are terminated.

As described above, the control device 30 can obtain a document from the document-shared network system 1 according to the rule formed through the rule-setting screen 150, and can smoothly execute the series of processes including processing and delivery of the document.

As has been described above in detail, in the embodiment, when a job flow obtained by expressing multiple processes performed to document information as one series of processes is transmitted to an external device which performs the series of processes to the document information to cause the external device to store and execute a series of processes so that the information processing apparatus performs one predetermined series of processes to the document information in cooperation with the external device, an operation designation input screen (corresponding here to the job flow cooperation setting screen 200) for inputting an operation designation for the job flow and a rule information input screen (corresponding here to the rule-setting screen 150) for inputting rule information serving as information which defines rules for conditions of a cooperation with the external device are displayed by a display (corresponding here to the display 34), a determining button (corresponding here to the OK button 197) designated when inputting of the operation designation and the rule information is terminated to fix an input result is displayed by the display, it is decided whether an operation for the job flow can be executed by the operation designation when the determining button is designated, when the decision unit decides that the operation cannot be executed, a reason why the operation cannot be executed is displayed by the display, and the display is controlled such that a re-execution button (corresponding here to the re-execution button 270) designated when the operation is re-executed is displayed by the display. For this reason, the state of the system is started to change when inputting of the operation designation for the job flow is ended. Even though an operation dependent on the input operation designation cannot be executed, the reason why the operation cannot be executed can be easily recognized by referring to the display contents of the display. As a result, measures against the fact that the operation dependent on the operation designation cannot be executed can be easily achieved, and the operation for a job flow can be easily re-executed merely by designating the re-execution button after the measures are performed.

In the embodiment, as the operation designation, a designation for the formation of a new job flow, a designation for the updating of a job flow stored in the external device, and a designation for the deletion of a job flow stored in the external device are applied. For this reason, various operations depending on these designations can all be performed to the job flow.

In the embodiment, a memory (corresponding here to the hard disk drive 36) is further arranged, the display is controlled such that a cancellation button (corresponding here to the cancellation button 271) designated when re-execution of the operation is canceled is further displayed, and the memory is controlled such that specific information (corresponding here to information representing a name of a job flow) for specifying a job flow to be operated of the operations which cannot be executed when the cancellation button is designated, operation contents for the job flow, and the reason why a job flow cannot be executed are stored in the memory. For these reasons, the apparatus can cope with a case in which the operation is re-executed later because a user wants to use a device on which the operation for the job flow cannot be reflected in another application, because the user personally wants to perform another operation, and the because the coping with the device cannot be immediately accomplished.

In addition, in the embodiment, in response to a case in which the reason why an operation cannot be executed is that account information of a person having no right to access the external device is input, the display is controlled such that an input screen (corresponding here to the user ID box 251A and the password box 251B) for inputting the account information of a person having the access right is further displayed. For this reason, the apparatus can easily cope with inexecution of an operation for a job flow caused by mismatching between the input account and the account having the access right.

The present invention has been described by using the embodiment. The technical scope of the invention is not limited to the scope described in the embodiment. The embodiment can be changed or modified without departing from the spirit and scope of the invention. A configuration obtained by changing or modifying the embodiment is also included in the technical scope of the invention.

The present embodiment is not limited to the invention defined in claims, and all combinations of characteristic features described in the embodiment are not always necessary for solving problems of the invention. The embodiment includes inventions on various stages. Various inventions can be extracted by appropriate combinations of multiple disclosed constituent elements. Even though several constituent elements are omitted from all the constituent elements disclosed in the embodiment, as long as an effect can be obtained, a configuration from which several constituent elements are deleted can be extracted as an invention.

For example, as sources of obtention and delivery destinations of documents, the compound machine 10, the mail server 20, and the terminal device 25 have been exemplified and explained. The invention is not limited to these elements. As the source of obtention of a document, for example, a scanner, a facsimile, a drive device of a storage medium such as a flexible disk drive (FDD) or an optical disk drive connected to the terminal device 25 may be used. In addition, as the delivery destination of a document, a facsimile, a copying machine, and a drive device of a storage medium connected to the terminal device 25 may be used. The rule-setting screen 150 is not limited to a screen displayed on the display of the control device 30. The rule-setting screen 150 may be displayed on the display of the terminal device 25.

As has been described above, the information processing apparatus according to the first aspect of the invention is an information processing apparatus which transmits to an external device a job flow obtained by expressing in the form of a series of processes multiple processes performed to document information. The external device performs a series of processes to the document information in order to store and execute the series of processes in such a way as to enable the information processing apparatus to perform a predetermined series of processes to the document information in cooperation with the external device. The apparatus comprises a display for displaying an operation designation input screen for inputting an operation designation for a job flow, a rule information input screen for inputting rule information serving as information which defines rules for conditions of cooperation with the external device and a determining button designated when inputting of the operation designation and the rule information has been terminated and an input result has been determined; a decision unit for deciding whether, when the determining button is designated, an operation for the job flow can be executed by the operation designation; and a controller for controlling the display in such a way that the display displays, when the decision unit decides that the operation cannot be executed, a reason why the operation cannot be executed, and displays also a re-execution button to be designated when the operation is re-executed.

In the invention, as the operation designation, at least one of a designation of the formation of a new job flow, a designation of updating a job flow stored in the external device, and a designation of deletion of job flow stored in the external device can be used.

In the invention, a memory may be further arranged, comprising a controller which preferably controls the display in such a way that a cancellation button, designated when re-execution of the operation is canceled, is further displayed, and the controller controls the memory in such a way that specific information is stored in the memory for specifying, when the cancellation button is designated, a job flow to be operated for operations, which cannot be executed, operation contents for the job flow, and a reason why the operation cannot be executed.

The memory may be a semiconductor storage device such as a RAM (Random Access Memory), an EEPROM (Electrically Erasable and Programmable Read Only Memory), or a flash EEPROM, a mobile storage medium such as a SmartMedia, an xD-picture Card, a Compact Flash, an ATA (AT Attachment) card, a microdrive, a floppy disk, a CD-R (Compact Disk-Recordable), a CD-RW (Compact Disk-ReWritable), or a photomagnetic disk, a fixed storage medium such as a hard disk drive, or an external storage device arranged in a server computer connected to a network.

Furthermore, in the invention, the controller preferably controls the display in such a way that in response to a case in which the reason why an operation cannot be executed is that account information of a person not having a right to access the external device has been input an input screen for inputting account information of persons having a right to access the external device is further displayed.

The second aspect of the invention provides a storage medium readable by a computer, the storage medium storing a program of instructions executable by the computer to perform a function for transmitting to an external device a job flow obtained by expressing in the form of a series of processes multiple processes performed to document information. The external device performs the series of processes to the document information in order to store and execute the series of processes in such a way as to enable the information processing apparatus to perform a predetermined series of processes to the document information in cooperation with the external device, the function comprising the steps of: (a) displaying an operation designation input screen for inputting an operation designation for the job flow, a rule information input screen for inputting rule information serving as information which defines rules for conditions of cooperation with the external device, and displaying on the display a determining button designated when inputting of the operation designation and the rule information has been terminated and an input result has been determined; (b) deciding, when the determining button is designated, whether an operation for the job flow can be executed by the operation designation; and (c) displaying on the display, when the decision unit decides that the operation cannot be executed, a reason why the operation cannot be executed and displaying on the display a re-execution button to be designated when the operation is re-executed.

In the invention, as operation designations, at least one of a designation of the formation of a new job flow, a designation of updating a job flow stored in the external device, and a designation of the deletion of a job flow stored in the external device can be used.

The invention preferably further includes the steps of: (d) further displaying on the display a cancellation button to be designated when re-execution of the operation is canceled and (e) when the cancellation button is designated, storing in the memory specific information for specifying a job flow to be operated for operations which cannot be executed operation contents for the job flow, and the reasons why the operations cannot be executed.

Furthermore, the invention preferably further includes the step of: (f) in response to a case in which the reason why an operation cannot be executed is that account information of a person not having a right to access the external device has been input, further displaying an input screen for inputting account information of persons having a right to access the external device.

1. An information processing apparatus, which performs a predetermined series of processes to document information in cooperation with an external device according to a job flow which expresses a plurality of processes performed to document information, the information processing apparatus comprising:
a display that displays an operation designation input screen that inputs an operation designation for the job flow and a rule information input screen that inputs rule information serving as information which defines rules for conditions of cooperation with the external device, and a determining button, which is designated when inputting of the operation designation and the rule information has been terminated and an input result has been determined;
a decision unit that decides, when the determining button is designated, whether an operation for the job flow can be executed by the operation designation; and
a controller that controls the display in such a way that the display displays, when the decision unit decides that an operation cannot be executed, a reason why the operation cannot be executed, and displays also a re-execution button, which is to be designated when the operation is re-executed.

2. The information processing apparatus of claim 1, wherein the operation designation is at least one of a designation of formation of a new job flow, a designation of updating a job flow stored in the external device, and a designation of deletion of a job flow stored in the external device.

3. The information processing apparatus of claim 1 further comprising a memory, wherein
the controller controls the display in such a way that the display further displays a cancellation button, which is to be designated when re-execution of the operation is canceled, and
the controller controls the memory in such a way that the memory stores specific information, when the cancellation button is designated, for specifying a job flow to be operated for an operation, which cannot be executed, operation contents for the job flow, and a reason why the operation cannot be executed.

4. The information processing apparatus of claim 1, wherein the controller controls the display such that, in response to a case in which a reason why an operation cannot be executed is that account information for a person not having a right to access the external device has been input, an input screen for inputting account information of persons having a right to access the external device is displayed.

5. A storage medium readable by a computer, the storage medium storing a program of instructions executable by the computer to perform a function for performing a predetermined series of processes to document information in cooperation with an external device according to a job flow which expresses a plurality of processes performed to document information, the function comprising:
(a) displaying an operation designation input screen that inputs an operation designation for the job flow, a rule information input screen that inputs rule information serving as information which defines rules for conditions of cooperation with the external device, and a determining button, which is to be designated when inputting of the operation designation and the rule information has been terminated and an input result has been determined;
(b) deciding, when the determining button is designated, whether an operation for the job flow can be executed by the operation designation; and
(c) when it is decided that an operation cannot be executed in (b), displaying on the display a reason why the operation cannot be executed, and displaying a re-execution button, which is to be designated when the operation is re-executed.

6. The storage medium of claim 5, wherein the operation designation is at least one of a designation of formation of a new job flow, a designation of updating a job flow stored in the external device, and a designation of deletion of a job flow stored in the external device.

7. The storage medium of claim 5 further comprising:
(d) further displaying a cancellation button, which is to be designated when re-execution of the operation is canceled; and
(e) storing in the memory, when the cancellation button is designated, specific information for specifying a job flow to be operated for operations, which cannot be executed, operation contents for the job flow, and a reason why the operation cannot be executed.

8. The storage medium of claim 5 further comprising:
(f) in response to a case, in which a reason why an operation cannot be executed is that account information for a person not having a right to access the external device has been input, further displaying an input screen for inputting account information of persons having a right to access the external device.

9. A method for an information processing apparatus, which performs a predetermined series of processes to document information in cooperation with an external device according to a job flow, which expresses a plurality of processes performed to document information, the method comprising:
(a) displaying an operation designation input screen that inputs an operation designation for the job flow, a rule information input screen that inputs rule information serving as information which defines rules for conditions of cooperation with the external device, and a determining button, which is to be designated when inputting of the operation designation and the rule information has been terminated and an input result has been determined;
(b) deciding, when the determining button is designated, whether an operation for the job flow can be executed by the operation designation; and
(c) when it is decided that an operation cannot be executed in (b), displaying on the display a reason why the operation cannot be executed, and displaying a re-execution button, which is to be designated when the operation is re-executed.

10. The method of claim 9, wherein the operation designation is at least one of a designation of formation of a new job flow, a designation of updating a job flow stored in the external device, and a designation of deletion of a job flow stored in the external device.

11. The method of claim 9 further comprising:
(d) further displaying a cancellation button, which is to be designated when re-execution of the operation is canceled; and
(e) storing, when the cancellation button is designated, specific information for specifying a job flow to be operated for operations, which cannot be executed, operation contents for the job flow, and a reason why the operation cannot be executed.

12. The method of claim 9 further comprising:
(f) in response to a case, in which a reason why an operation cannot be executed is that account information for a person not having a right to access the external device has been input, further displaying an input screen for inputting account information of persons having a right to access the external device.
